(19) United States
(12) Patent Application Publication
(10) Pub. No.: US 2014/0266520 A1
(43) Pub. Date: Sep. 18, 2014

(54) TRIP ACTUATOR FOR SWITCH OF ELECTRIC POWER CIRCUIT

(71) Applicant: LSIS CO., LTD., Anyang-si (KR)

(72) Inventor: Young Woo JEONG, Cheongju-si (KR)

(73) Assignee: LSIS CO., LTD., Anyang-si (KR)

(21) Appl. No.: 14/171,622

(22) Filed: Feb. 3, 2014

(30) Foreign Application Priority Data
Mar. 14, 2013 (KR) 10-2013-0027459

(51) Int. Cl. H01H 71/24

(52) U.S. Cl. CPC H01H 71/2481
USPC 335/38

(57) ABSTRACT

The present disclosure relates to a small-sized trip actuator for a switch of an electric power circuit, capable of triggering a switching mechanism to a circuit opening position at fast speed by minimizing a delay of time, the trip actuator including a main driving unit configured by a solenoid actuator comprises an output pin which is linearly movable, and a sub driving unit configured by a Thomson drive unit comprises a repulsive plate connected to the output pin, and a Thomson coil causing the repulsive plate to be repulsively moved when a current flows therethrough, such that the output pin is linearly moved, the sub driving unit operating to linearly move the output pin, before the main driving unit operates, upon opening the electric power circuit.

### CROSS-REFERENCE TO RELATED APPLICATION

Pursuant to 35 U.S.C. §119(a), this application claims the benefit of earlier filing date and right of priority to Korean Application No. 10-2013-0027459, filed on Mar. 14, 2013, the contents of which is incorporated by reference herein in its entirety.

### BACKGROUND OF THE DISCLOSURE

1. Field of the Disclosure

This specification relates to a trip actuator for a switch of an electric power circuit, such as a circuit breaker, a switch and a switchgear, which opens or closes the electric power circuit in an electric power transmission and distribution system, and more particularly, a small, high-speed trip actuator which is capable of triggering a switching mechanism, the switching mechanism provides a driving force for switching contacts, to a circuit breaking position (or a trip position).

2. Background of the Disclosure

In order to break an electric power circuit when a fault current, such as an electric shortage or an electric leakage, occurs on the electric power circuit, a switchgear of the electric power circuit may require for a switching mechanism, which is a mechanism for driving a movable contact to an opening position (i.e., a circuit breaking position or a trip position) where the movable contact is separated from a stationary contact. Such switching mechanism uses elastic force of a spring, hydraulic pressure, pneumatic force, electronic attractive force and the like. Especially, the spring type switching mechanism using the elastic force of the spring is widely used in view of excellent performances, such as high operation reliability, simplicity of fabrication and the like.

The spring type switching mechanism uses a status restricting mechanism, such as a latch, for maintaining a trip spring in a charged state in order to ensure elastic energy for breaking a circuit. The spring type switching mechanism also uses a small-sized actuator to manipulate the latch to a release position so as to release the restricted trip spring and discharge the charged elastic energy. The spring type switching mechanism additionally uses a driving force transfer mechanism, such as a plurality of links, so as to transfer the discharged elastic energy to a movable contact, thereby opening the electric power circuit.

The present disclosure relates to a small-sized actuator, for a switch of the electric power circuit, which is capable of manipulating (triggering) the latch to the release position such that the switching mechanism can be driven to an opening position.

For the switch of the electric power circuit, representatives of the small-sized actuator, which manipulates the latch to the release position such that the switching mechanism is moved to the opening position, may include a solenoid actuator or a permanent magnetic actuator.

Examples of the solenoid actuator or the permanent magnetic actuator may be understood by referring to the following prior art documents, namely, Korean Utility model Registration No. 20-0386948 (Name of the invention: Foreign material introduction preventing structure of solenoid actuator), and Korean Patent Registration No. 10-1045167 (Name of the invention: Cylindrical bistable permanent magnetic actuator).

However, the solenoid actuator and the permanent magnetic actuator use a magnetic attractive force of a ferromagnetic substance responsive to a magnetization of a coil. Hence, a delay of, for example, about 5 to 6 msec may be caused until a driving force is applied. When a protection circuit is employed to prevent damage of the coil, it may delay the time by about 10 to 13 msec.

### SUMMARY OF THE DISCLOSURE

Therefore, to obviate those drawbacks of the related art, an object of the invention is to provide a small-sized trip actuator for a switch of an electric power circuit, capable of triggering a switching mechanism to a circuit opening position at fast speed by minimizing a delay of time.

To achieve these and other advantages and in accordance with the object of this invention, as embodied and broadly described herein, there is provided a trip actuator for a switch of an electric power circuit, the trip actuator comprising:

a main driving unit comprises an output unit which is linearly movable; and

a sub driving unit comprises a portion connected to the output unit, and a a drive unit to drive the portion, the sub driving unit operating to linearly move the output unit, before the main driving unit operates, upon opening the electric power circuit.

To achieve these and other advantages and in accordance with the object of this invention, as embodied and broadly described herein, there is provided a trip actuator for a switch of an electric power circuit according to the invention, the trip actuator comprises:

a main driving unit comprises a stationary core,

a movable core movable close to the stationary core or away from the stationary core,

a driving coil configured to apply a magnetic attractive force to the movable core to be moved toward the stationary core when being magnetized, and

a trigger pin connected to the movable core to be linearly movable together with the movable core; and

a sub driving unit comprises a repulsive plate connected to the trigger pin to be movable together with the trigger pin and made of an electric conductor, and

a coil drive unit installed to face the repulsive plate and configured to generate a repulsive force such that the repulsive plate is moved away therefrom when being magnetized by an electric control signal.

In accordance with one aspect of the present disclosure, the main driving unit comprises a solenoid actuator having a linearly movable output pin.

In accordance with another aspect of the present disclosure, the sub driving unit comprises:

a repulsive plate connected to the output unit; and

a Thompson drive unit having a Thompson coil make the output unit linearly move by causing the repulsive plate to be repulsively moved when a current flows through the Thompson coil.

In accordance with still another aspect of the present disclosure, the main driving unit comprises a solenoid actuator.

In accordance with still another aspect of the present disclosure, the sub driving unit comprises a Thompson coil configured to generate a repulsive force such that the repulsive plate is moved away therefrom when being magnetized by an electric control signal.

In accordance with still another aspect of the present disclosure, the trip actuator further comprises:

a spring installed between the movable core and the stationary core and configured to apply an elastic force to the movable core such that the movable core is moved away from the stationary core when the driving coil is demagnetized.

In accordance with still another aspect of the present disclosure, the stationary core and the movable core are made of a ferromagnetic substance.

Further scope of applicability of the present application will become more apparent from the detailed description given hereinafter. However, it should be understood that the detailed description and specific examples, while indicating preferred embodiments of the disclosure, are given by way of illustration only, since various changes and modifications within the spirit and scope of the disclosure will become apparent to those skilled in the art from the detailed description.

### BRIEF DESCRIPTION OF THE DRAWINGS

The accompanying drawings, which are included to provide a further understanding of the disclosure and are incorporated in and constitute a part of this disclosure, illustrate exemplary embodiments and together with the description serve to explain the principles of the disclosure.

In the drawings:

FIG. 1 is a longitudinal sectional view illustrating a configuration of a trip actuator for a switch of an electric power circuit in accordance with a preferred embodiment of the present invention, which illustrates a status that a sub driving unit and a main driving unit are in a non-operating state; and

FIG. 2 is a longitudinal sectional view illustrating the configuration of the trip actuator for the switch of the electric power circuit in accordance with a preferred embodiment of the present invention, which illustrates a status that a trigger pin has been moved responsive to an operation of the sub driving unit.

### DETAILED DESCRIPTION OF THE DISCLOSURE

Hereinafter, description will be given in detail of a configuration and an operating effect of a preferred one exemplary embodiment of the present disclosure with reference to the accompanying drawings.

Description will be given of a configuration of a trip actuator for a switch of an electric power circuit in accordance with a preferred exemplary embodiment with reference to FIGS. 1 and 2, hereinafter.

As illustrated in FIG. 1, a trip actuator 100 for a switch of an electric power circuit according to a preferred exemplary embodiment may roughly include a main driving unit 1 and a sub driving unit 2.

The main driving unit 1 may be configured by a solenoid actuator, and include a trigger pin 16 which is a linearly movable output pin.

In more detail, the main driving unit 1, referring to FIG. 1, may include a stationary core 15, a movable core 14, a driving coil 13 and a trigger pin 16 as the output pin.

The main driving unit 1 may further include a bobbin 10, a first cover 11, a second cover 12 and a spring 17.

The bobbin 10 may be provided as a supporting member for winding the driving coil 13.

The first cover 11 may be provided as a cover portion to cover one end portion (i.e., an upper end portion in FIG. 1) of the bobbin 10.

The second cover 12 may be provided as a cover portion to cover the other end portion (i.e., a lower end portion in FIG. 1) of the bobbin 10.

The spring 17 may be installed between the movable core 14 and the stationary core 15 to apply an elastic force to the movable core 14 such that the movable core 14 can be moved away from the stationary core 15 when the driving coil 13 is demagnetized.

A reference numeral 18 in FIG. 1 designates an enclosure which accommodates therein entire components of the trip actuator 100.

The stationary core 15 which is a core with a position fixed may be made of a ferromagnetic substance. The stationary core 15 may be magnetized or demagnetized according to whether or not a magnetic field of the driving coil 13 located on an outer side of the stationary core 15 with surrounding the stationary core 15 is applied to the stationary core 15.

The movable core 14 may be a core which is made of a ferromagnetic substance and installed on a position facing the stationary core 15 so as to be movable close to and far away from the stationary core 15. When the magnetic field of the driving coil 13 is applied, the movable core 14 may be moved close to the stationary core 15. When the magnetic field of the driving coil 13 is not applied, the movable core 14 may be moved away from the stationary core 15 by the elastic force of the spring 17.

The driving coil 13 may be installed on an outer side of the stationary core 15 and the movable core 14 so as to surround the stationary core 15 and the movable core 15. Accordingly, the driving coil 13 may apply a magnetic attractive force to the movable core 14 to be moved toward the stationary core 15 when the driving coil 13 is magnetized in response to a magnetization control current supplied through a control signal line (not shown) connected to the driving coil 13.

The trigger pin 16 may be an output shaft, namely, an output pin of the trip actuator 100. The trigger pin 16 may be connected to the movable core 14 so as to be linearly movable together with the movable core 14. Referring to FIG. 1 or 2, the trigger pin 16 may be linearly movable up and down.

The trigger pin 16 may be located at a contactable position with the latch when being linearly moved, such that the latch of the switching mechanism, as a switching driving unit of a switch, such as a circuit breaker, is driven to a release position.

The sub driving unit 2 may be configured by a Thomson drive unit which includes a repulsive plate 20, and a Thomson coil 19. The sub driving unit 2 may operate, earlier than the main driving unit 1 (i.e., before the main driving unit 1 operates), to linearly move the trigger pin 16 as the output pin upon opening the electric power circuit.

The repulsive plate 20 may be a plate-shaped member made of an electric conductor. The repulsive plate 20 may be connected to the trigger pin 16 to be movable together with the trigger pin 16 and installed to face the Thomson coil 19.

When the Thomson coil 19 is magnetized in response to s magnetization control current supplied to the Thomson coil 19 through a control signal line (not shown), an eddy current may be induced on the repulsive plate 20 which faces the Thomson coil 19. A repulsive force may then be generated as a magnetic force generated by the eddy current and a magnetic force of the Thomson coil 19 are repulsed against each other. Accordingly, the repulsive plate 20 may be linearly moved away from the Thomson coil 19 (i.e., downwardly in FIG. 1) without substantial time delay, thereby being converted into a status illustrated in FIG. 2.

When a current flows on the Thomson coil 19, namely, the magnetization control current as a control signal is applied to the Thomson coil 19 through the control signal line, a repulsive force may be generated between the Thomson coil 19 and the repulsive plate 20 such that the repulsive plate 20 can be moved away from the Thomson coil 19. This may allow the trigger pin 16 to be linearly moved to a position illustrated in FIG. 2 in a downward direction.

Hereinafter, description will be given of an operation of the trip actuator 100 for the switch of the electric power circuit according to the preferred embodiment, with reference to FIGS. 1 and 2.

First, a controller of the switch may detect an occurrence of a fault current, such as a short-circuit current or a ground fault current, on the electric power circuit, and then apply a magnetization control current as a control signal simultaneously to the Thomson coil 19 and the driving coil 13 through a control signal line (not shown). In response to the magnetization control current, the sub driving unit 2 may operate first, followed by the main driving unit 1.

That is, when the Thomson coil 19 is magnetized by the magnetization control current, an eddy current may be induced on the repulsive plate 20 installed to face the Thomson coil 19. A repulsive force may then be generated as a magnetic force generated by the eddy current and a magnetic force of the Thomson coil 19 are repulsed against each other. Accordingly, the repulsive plate 20 may be linearly moved away from the Thomson coil 19 (i.e., downwardly in FIG. 1) without substantial delay of time, thereby being converted into a status illustrated in FIG. 2.

The trigger pin 16 connected to the repulsive plate 20 may thusly press a latch (not shown) in a contact manner, such that the latch is moved to a release position.

Here, the main driving unit 1 may maintain the released state of the latch after a time delay.

That is, when the driving coil 13 is magnetized by the magnetization control current supplied through the control signal line connected thereto, the driving coil 13 may apply a magnetic attractive force to pull the movable core 14 toward the stationary core 14. Accordingly, the trigger pin 16 connected to the movable core 14 may be linearly moved from the position of FIG. 1 to the position of FIG. 2 by virtue of a stronger driving force than that of the sub driving unit 2.

The trigger pin 16 linearly moved down may allow the latch to remain released.

Consequently, a trip spring of the switching mechanism of the switch may be released to discharge charged elastic energy. The elastic energy discharged from the trip spring may be transferred to a movable contact (not shown) through a driving force transfer mechanism (not shown), such as a plurality of links, such that the movable contact can be separated from a corresponding stationary contact. The electric power circuit may thusly be opened (broken), and then the electric power circuit and electric load devices connected to the electric power circuit may be fast protected from the fault current.

Here, according to the present disclosure, the main driving unit 1 configured by the solenoid actuator may have an operation delay time as long as 5 msec (milli-second), for example, although it is the solenoid actuator with a short delay time, but the sub driving unit 2 configured by the Thomson drive unit may merely consume an operation time shorter than 1 msec even if it has an electric response delay time. Hence, the sub driving unit 2 may operate at high speed to minimize the time delay and thus release the locked latch. This may provide an effect in that circuit opening (tripping) of the switch of the electric power circuit may be executed at fast speed.

On the other hand, at the position of FIG. 2, when the magnetization control current as the control signal is not applied any more from the controller of the switch to the Thomson coil 19 and the driving coil 13 through the control signal line, the following operation may be executed.

That is, without the magnetization control current, the Thomson coil 19 may be demagnetized, and the eddy current may not be induced any more on the repulsive plate 20 facing the Thomson coil 19. Accordingly, the repulsive force generated between the magnetic force generated by the eddy current and the magnetic force of the Thomson coil 19 may be extinguished.

Also, since the excitation current supplied to the driving coil 13 of the main driving unit 1 through the control signal line connected thereto is not applied as well, the driving coil 13 may also be demagnetized and the magnetic attractive force applied to the movable core 14 to be moved toward the stationary core 15 may be extinguished.

When the driving coil 13 is demagnetized, the spring 17 installed between the movable core 14 and the stationary core 15 may apply an elastic force to the movable core 14 to be moved away from the stationary core 15. Accordingly, the movable core 14, the trigger pin 16 and the repulsive plate 20 may be linearly moved from the position of FIG. 2 to the position of FIG. 1.

The trigger pin 16 may thusly be located at a position away from the position where it presses the latch in the contact manner.

As described above, in the trip actuator 100 for the switch of the electric power circuit, the sub driving unit 2 configured by the Thomson drive unit may be configured with a smaller capacity than the main driving unit 1, which may result in implementing a small-sized, high-speed trip actuator for a switch of an electric power circuit.

The trip actuator 100 may further include the spring 17 which is installed between the movable core 14 and the stationary core 15 to apply an elastic force to the movable core 14 to be away from the stationary core 15 when the driving coil 13 is demagnetized. Hence, when the driving coil 13 is demagnetized without a control signal applied to the driving coil 13 of the solenoid actuator, the movable core 14 may be automatically restored to a position spaced from the stationary core 15.

In the trip actuator 100 for the switch of the electric power circuit, since the stationary core 15 and the movable core 14 are made of the ferromagnetic substance, they may be strongly attracted by each other when the driving coil 13 is magnetized, which may allow the trigger pin 16 connected to the movable core 14 to be moved together with the movable core 14, thereby driving the latch to the release position.

The foregoing embodiments and advantages are merely exemplary and are not to be construed as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A trip actuator for a switch of an electric power circuit, the trip actuator comprising:
a main driving unit including an output unit which is linearly movable; and
a sub driving unit including a portion connected to the output unit, and a a drive unit to drive the portion, the sub driving unit operating to linearly move the output unit, before the main driving unit operates, upon opening the electric power circuit.

2. The trip actuator according to claim 1, wherein the main driving unit comprises a solenoid actuator having a linearly movable output pin.

3. The trip actuator according to claim 1, wherein the sub driving unit comprises:
a repulsive plate connected to the output unit; and
a Thompson drive unit having a Thompson coil make the output unit linearly move by causing the repulsive plate to be repulsively moved when a current flows through the Thompson coil.

4. A trip actuator for a switch of an electric power circuit, the trip actuator comprising:
a main driving unit including a stationary core,
a movable core movable close to the stationary core or away from the stationary core,
a driving coil configured to apply a magnetic attractive force to the movable core to be moved toward the stationary core when being magnetized, and
a trigger pin connected to the movable core to be linearly movable together with the movable core; and
a sub driving unit including a repulsive plate connected to the trigger pin to be movable together with the trigger pin and made of an electric conductor, and
a coil drive unit installed to face the repulsive plate and configured to generate a repulsive force such that the repulsive plate is moved away therefrom when being magnetized by an electric control signal.

5. The trip actuator according to claim 4, wherein the main driving unit comprises a solenoid actuator.

6. The trip actuator according to claim 4, wherein the sub driving unit comprises a Thompson coil configured to generate a repulsive force such that the repulsive plate is moved away therefrom when being magnetized by an electric control signal.

7. The trip actuator according to claim 4, further comprising:
a spring installed between the movable core and the stationary core and configured to apply an elastic force to the movable core such that the movable core is moved away from the stationary core when the driving coil is demagnetized.

8. The trip actuator according to claim 4, wherein the stationary core and the movable core are made of a ferromagnetic substance.
